(19) United States
(12) Patent Application Publication
(10) Pub. No.: US 2019/0043131 A1
(43) Pub. Date: Feb. 7, 2019

(54) Infrastructure Development

(71) Applicant: SIEMENS AKTIENGESELLSCHAFT, MUENCHEN (DE)

(72) Inventor: STEFFEN SCHAEFER, MUENCHEN (DE)

(21) Appl. No.: 16/073,858

(22) PCT Filed: Jan. 29, 2016
(86) PCT No.: PCT/EP2016/051948

§ 371 Date: Jul. 30, 2018

(51) Int. Cl. G06Q 40/06; H04W 4/029; G06Q 50/08

(52) U.S. Cl. CPC G06Q 40/06; G06Q 50/08; H04W 4/029

(57) ABSTRACT

A device has a database containing information about construction projects for an infrastructure network. A geographical area affected by the construction project is associated with each construction project. The device also has an interface for communication with a mobile terminal of a user and a processing device. The processing device is configured to determine the position of the mobile terminal, to transmit information to the mobile terminal about a construction project with an associated geographical area containing the position, and to receive an investment instruction from a user of the mobile appliance for the implementation of the construction project.

The invention relates to the development of an infrastructure. In particular, the invention relates to the organization and prioritization of a construction project in an infrastructure network.

A road network is set up for public use by persons who, for example, can drive on the road network by means of motor vehicles. A motor vehicle can be equipped with an electronic assistant or an information system to improve the driving of the motor vehicle on the road network. For example, the motor vehicle can include a wireless interface for receiving and transmitting information relating to a local traffic incident.

For technologies that improve control or organization of a traffic flow on the road network, in addition to a mobile component, a stationary component that can be assigned to the road network is often also required. For example, if communication is to take place between the motor vehicle and a fixed infrastructure (car-to-infrastructure, C2i), such an infrastructure must be available and be operated in the area of a portion of the road network in order to enable the data exchange. For example, if information about a current traffic light phase in the region of an intersection is to be transmitted wirelessly to a motor vehicle, this then requires a transmitting device that is connected to a control unit for the traffic lights, and a receiving device on board a motor vehicle in this area.

The transport network is usually operated by public services, which usually provide only limited resources for the development of a technical infrastructure for the road network. This means that the extent of the roll-out of advanced technologies that would in some cases be helpful to all users of the transport network may be restricted.

Document US 2001/0 0252 841 A1 discloses a method for forwarding information to a mobile terminal, for example in a vehicle. Here the information can include advertising. First a position of the mobile terminal is determined. Before it is transmitted, the information is selected from a database in a location-dependent manner depending on the position of the mobile terminal. After it has been transmitted, the information is displayed via an interface, such as a screen.

The object of the invention is to provide technology for expanding an infrastructure, which in particular supports the wider use of a technical system that includes fixed and mobile system components. The invention achieves this object by means of the subject matter of the independent claims. The sub-claims specify preferred embodiments.

An apparatus includes a database that contains information about construction projects for an infrastructure network, a geographical area affected by the construction project being assigned to each construction project. The apparatus further includes an interface for communication with a mobile terminal relating to a user, and a processing system. The processing system is equipped to determine the position of the mobile terminal, to transmit to the mobile terminal information about a construction project, the assigned geographical area of which includes the position, and to receive an investment instruction from a user of the mobile device for carrying out the construction project.

Using the apparatus, a road user may directly activate a personal investment for a construction project that relates to a geographical area where said road user is located. This allows the user to intervene actively in the prioritization of construction projects. If there are enough users activating an investment for a construction project, this construction project can thus be carried out immediately. The raising of funds, especially of public funds, is then in some cases no longer necessary. A property developer for the construction project, such as an office administration or a government, may then only have to become involved in reduced planning or administrative operations. An operator of the apparatus may request a fee for the use thereof, which can be levied as desired either from a user, from a body carrying out the construction project, or from both. A plurality of construction projects can be organized in combination from a central location. The construction projects may be the responsibility of different organizations that have recourse to a common database. A user can activate a dedicated investment without the knowledge of the competent authorities within an organization. As a result, a direct and transparent interrelation can be achieved between the investment and a noticeable impact for the user when they use the infrastructure network after the completion of the construction project.

The apparatus can be used in particular by means of a mobile terminal that a user carries with them, such as a smartphone. Alternatively, a mobile terminal, via which the apparatus can be contacted, may be mounted on board a motor vehicle. Thus, a road user at his current location in the infrastructure network can make an investment decision, for example, on the basis of a currently prevalent usage situation (such as a traffic jam).

The investment instruction preferably relates to a sum of money and the processor is equipped to perform a transfer of the amount from an account belonging to the user. In other words, the apparatus may be configured to immediately perform a money transfer or the transfer of a monetary unit from the user into a dedicated account. The user's account and the dedicated account may each include, for example, a bank account, a virtual wallet (bitcoin) or a substitute or reference currency that allows the transfer of a monetary unit. The aim of the transfer is in any case to provide directly the sum required for the implementation of the construction project so that the construction project can be started without further raising financial funding.

In a further embodiment, means for continuing a construction project that is not yet completed may be collected in the manner described. This can be useful for example, in large construction projects that are divided into several phases or sections, or in the case of a subsequent increase in costs.

A method includes steps of determining a position of a mobile device, detecting a construction project for an infrastructure network, wherein a geographical area of the infrastructure network that is affected is assigned to the construction project, said area including the position from which information about the construction project is transmitted to the mobile device and at which an investment instruction from a user of the mobile device for the implementation of the construction project is received.

The method may be used in particular to collect investments such as donations to support a construction project on the infrastructure network. By correlating the affected geographical area of the infrastructure network with the position of the mobile device, the user can be more effectively placed in a position to make his investment decisions dependent on conditions that he encounters on site. In this way, the collection and presentation of additional information about the construction project can be avoided.

The information about the construction project can include virtually any type of information. It is preferable, however, that in particular such information is included, which can facilitate an investment decision. This may include, in particular, an investment amount required for the implementation of the construction project, an investment amount relating to investment instructions already received, an investment amount of investment instructions still required for the implementation of the project or a number of investment instructions received.

The infrastructure network preferably includes a transport network and more preferably a road network. The method can be used by any persons who have access to a mobile terminal the position whereof can be detected in the area of the infrastructure structure network. In a further embodiment, the requesting of information about a construction project, and the transmission of an investment decision can be supported by a terminal that is not located in the area involved. This procedure is similar to that of a conventional crowdfunding portal.

In a particularly preferred embodiment, the information includes an indication of an intended impact of the completed construction project on traffic in the affected area of the infrastructure network. For example, in connection with a construction project, an indication can be given that a reduction in a motorist's average waiting time at a traffic light from three minutes to one minute is intended as a result of the construction project.

A computer program product includes program coding means to perform the method described when it is run on a processing system or stored on a computer-readable medium.

The characteristics, features and advantages of the present invention described above and the manner of attaining them will be clearer and more fully understood in connection with the description that follows of the exemplary embodiments, which are explained in greater detail in connection with the drawings, wherein

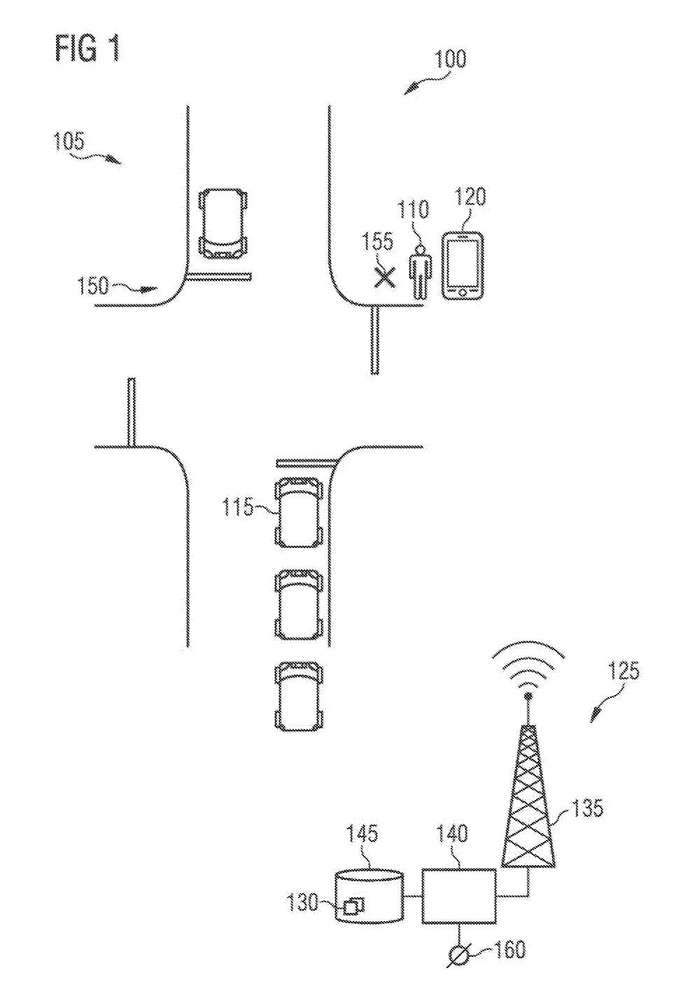

FIG. 1 shows a system;

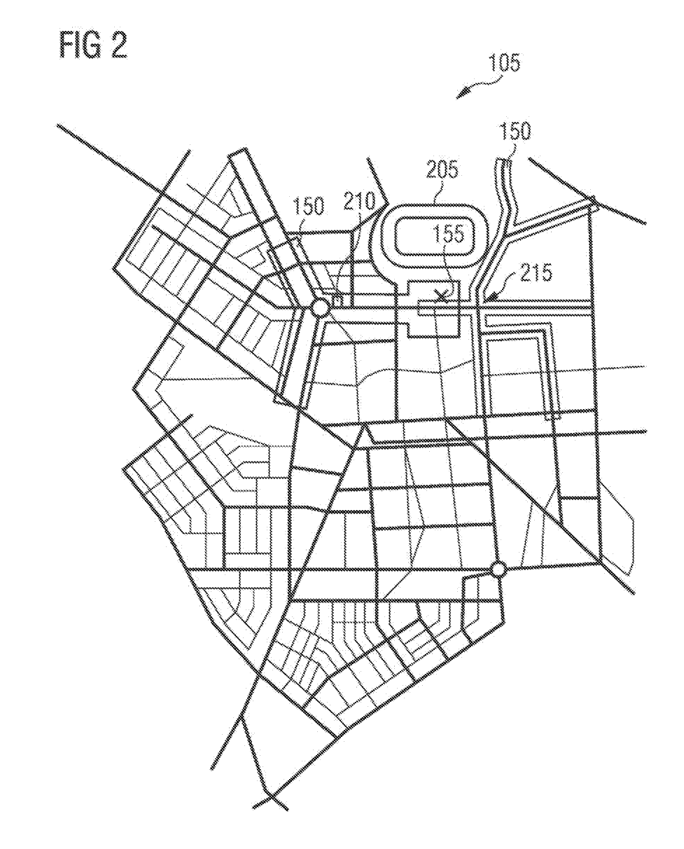

FIG. 2 shows an infrastructure network with areas that are affected by construction projects; and

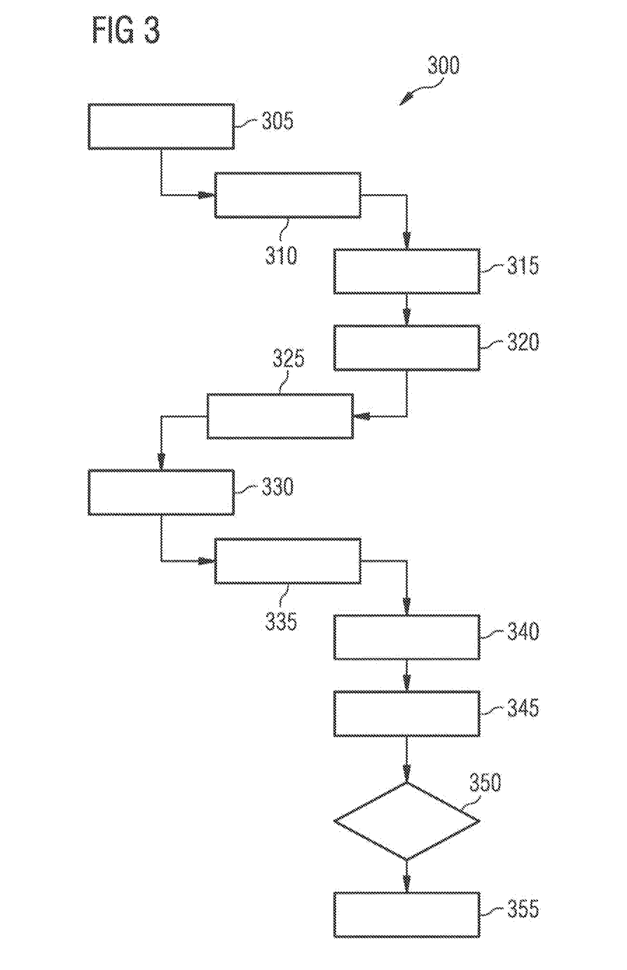

FIG. 3 is a flowchart of a method.

FIG. 1 shows a system 100. An infrastructure network 105 is shown as a transport network, in particular as a road network. The infrastructure network 105 is usually set up for use by persons 110, who can use the infrastructure network 105 in various ways. For example, a first person 110 may be on foot, a second may be in a motor vehicle 115, and a third may be traveling by another means of transport such as a bicycle, a motorcycle or a bus. For the present invention, it is assumed that during the use of the infrastructure network 105, the person 110 has access to a mobile terminal 120 that can be configured, for example, as a smart phone or as a fixed or removably installed device on board the motor vehicle 115. The mobile terminal 120 includes a wireless interface that is particularly equipped to communicate with an apparatus 125, which will be further described in more detail below. The communication with the apparatus 125 may ensue, for example, via a wireless communication network such as WLAN, via an area of the internet, or via a mobile phone network.

While using the infrastructure network 105, the person 110 can obtain information about a construction project 130 that relates to the place in which the person 110 happens to be located. For this purpose, the position 155 of the person 110 or of the mobile terminal 120 is preferably determined and sent to the apparatus 125, together with a request for information, for example. The apparatus 125 includes a wireless interface 135, a processing system 140 and a database 145, in which information about the construction project 130 on the infrastructure network 105 is stored. If the mobile terminal 120 is not equipped to determine the person's position 155, in one embodiment the position 155 can be entered by the person 110. In a further embodiment, the position 155 can also be estimated on the basis of connection parameters that are present, for example, in the wireless communication with the apparatus 125. For example, when a cell-based mobile network is used, the radio cell used can be identified by the apparatus 125. The position 155 of the person 110 or of the mobile terminal 120 is then located in the radio cell that has been identified, for example in the geometric center thereof.

Each construction project 130 relates to a predetermined geographical area 150 of the infrastructure network 105. In the embodiment shown by way of example in FIG. 1, the area 150 can include, for example, the intersection shown. Usually, the area 150 extends along a traffic route of the infrastructure network 105. In other cases, however, the area 150 can be circular, elliptical or rectangular in shape, for example. The area 150 preferably includes all the traffic routes that are affected by the construction project 130. For this purpose, a plurality of areas 150 that do not necessarily have to be connected can be defined.

An assumed position 155 of the person 110 or of the mobile device 120 is drawn by way of example. The apparatus 125 then determines one or a plurality of construction projects 130, the assigned geographical areas whereof 150 include in each case the position 155 of the user 110 or of the mobile device 120.

In a further embodiment, a comparison is made as to whether or not the position 155 of the user 110 or of the mobile device 120 is located in the area 150 of a construction project 130, on the basis of a unique identifier, for example a multiple-digit number or a character string. In this case, it is possible to determine, on the basis of a position 155, one or a plurality of identifiers that each refer to an area 150 of the infrastructure network 105, for example to a section of road, an intersection, an underpass or an area defined by a polygon. One or a plurality of such identifiers can be assigned to each construction project 130, such that the determination of construction projects 130 can be carried out easily and efficiently on the basis of identifiers. The determination of a Euclidean distance between a position 155 and an area 150, for example, can thus be avoided when searching for the construction project 130.

Additional information, which is preferably stored in the database 145, is assigned to each construction project 130. This information may then be transmitted by the apparatus 125 to the mobile device 120 belonging to the person 110. This allows the person 110 to receive an impression as to which construction projects 130 can improve the use of the infrastructure network 105 at position 155, where they are currently located and, ideally, how this can be done. If, for example, the person 110 receives the impression that a traffic light in the area 150 (in the example shown, the intersection), which only allows the road to be crossed very slowly, they can be informed in the manner described about construction projects 130 that influence the traffic situation in the area 150 and possibly remedy the poor situation perceived by the person 110. Such a construction project 130 may include, for example, the transmission to mobile terminals 120 in the area 150 of a traffic light phase of traffic lights at the intersection shown.

The construction projects 130 are usually linked to the provision of predetermined resources. In particular, a construction project 130 can only start or only be continued if financing of the project 130 is guaranteed. It is to be expected that more construction projects 130 will exist than can be covered or financed by an operator of the infrastructure network 105. Because of the information made available here about one or a plurality of construction projects 130, the person 110 may decide to make an investment in a specific construction project 130. Some of the resources necessary for the realization of the construction project 130, particularly finance, can be covered by this. If there are sufficient persons 110 who wish to activate such an investment, then the total investment required for the implementation of the construction project 130 can be achieved, so that the construction project can be realized. The user 110 will preferably transmit to the apparatus 125 via the mobile terminal 120 an investment instruction that includes an indication of an investment (a resource, usually in the form of cash) that is to be activated and an indication of the construction project 130 to which it is assigned. The apparatus 125 may forward the investment instruction via an optional interface 160 to an executing institution, for example, a bank patronized by the user 110, or a financial institution in order for it to be carried out. In another embodiment, the apparatus 125 can even carry out the investment itself, in particular by transferring a resource, usually money, from an account held by the user 110 or paying it into an account that is available for the realization of the construction project 130.

FIG. 2 shows an exemplary infrastructure network 105 with examples of areas 150 that are affected by construction projects 130 that are also exemplary. The infrastructure network 105 again includes a traffic network, in particular a road network of a fictitious and exemplary small town. In the infrastructure network 105 are a sports stadium 205, a traffic light 210 on a road near the sports stadium 205, and an intersection 215, also close to the sports stadium 205. An exemplary assumed position 155 of the user 110 or of their mobile terminal 120 is marked.

The following exemplary construction projects 130 are assumed:

First construction project 220

| | |
|---|---|
| Description | Optimization of waiting times |
| Area | Wasserburger Landstrasse |
| Construction time | 2 months |
| Total investment | €23,130 |
| Already invested | €15,497 |
| Percentage covered | 67% |
| Number of investments | 6,823 |
| Aim of construction | Improving the control of the |
| | traffic lights 210 depending |
| | on traffic and on major |
| | events in the stadium 205 |

Second construction project 225

| | |
|---|---|
| Description | Roadside unit |
| Area | Intersection 215 |
| | Theresienhöhe/Hans-Fischer-Str. |
| Construction time | 3 months |
| Total investment | €121,220 |
| Already invested | €29,093 |
| Percentage covered | 24% |
| Number of investments | 5,819 |
| Aim of construction | Transmission of traffic light |
| | signal phases to the motor |
| | vehicle 115 |

The aforementioned roadside unit may in particular include a stationary fixed communication device which is embodied for communication with vehicles 115 or mobile terminals 120. A communication enabled thereby between road users and an infrastructure is also known as C2i communications. Capital and operating costs for such a roadside unit usually have to be allocated to the costs for a section of the infrastructure network 105. In some cases, the equipping of motor vehicles 115 with communication and processing systems, and the equipping of the infrastructure network 105 with one or a plurality of roadside units is necessary for a desired technology that may have the impact, for example, of relieving traffic.

Areas 150 that are assigned to the construction projects 220 and 225 overlap and include the position 155. Now, for example, if the user 110 is located in unsatisfactory traffic conditions at the position 155, he can then be informed in the manner described above about the two construction projects 220 and 225 and can decide for himself whether he wants to activate an investment for the implementation of the projects in one of the two construction projects or in both. Here he can make his decision dependent on information which is set out by way of example in the above tables. In other embodiments, different or additional information may be provided for the construction projects 220, 225, for example, a map, information graphics, a simulation, statistics, and so on. Advantageously, it may be irrelevant to the user 110 as to which person or institution is responsible for the implementation of the construction project 130. In the example shown, for instance, the construction project 220 may be the responsibility of a town and the construction project 225 may be the responsibility of a county or federal state.

FIG. 3 shows a flow chart of a method 300. The method 300 is equipped to run on the system 100 shown in FIG. 1. Processing steps shown on the left-hand side of FIG. 3 are preferably performed here on the mobile terminal 120; steps that are shown on the right for performing the method are carried out by the apparatus 125; and processing steps shown in the center are optionally carried out by a communications system such as a mobile radio network. The sequence of steps shown is not binding, and a person skilled in the art can easily detect and implement alternative sequences to carry out the steps.

In a step 305, a position 155 of the terminal 120 or of the user 110 is determined. This position 155 is preferably transmitted to the apparatus 125 together with a request in a step 310. As already described above, the position 155 of the user 110 and of the mobile terminal 120 can be determined in different ways that can be used as an alternative to the method 300.

In a step 315, one or a plurality of construction projects 130 are determined, the respective designated areas 150 of which include the position 155 that has been determined. The construction projects 130 are preferably stored in a database 145, such that the determination of the construction projects 130 can include a query to the database 145. Prior to the method 400 being run, information about construction projects 130 has preferably been incorporated into the database 145 for this purpose. The definition of construction projects 130 usually precedes incorporation into the database 145. Information relating to the construction projects 130 that have been determined is preferably obtained in a subsequent step 320. This information can be taken in particular from the database 145. After it has been acquired, the information is transmitted in a step 325 to the mobile terminal 120 belonging to the user 110. The user 110 may then, on the basis of the information received, make an investment decision for one or a plurality of construction projects 130 and issue a corresponding investment instruction. The investment instruction preferably includes a legally binding decision to provide a predetermined resource, usually an amount of money that is selectable by the user 110 for the realization of the construction project 130.

The investment instruction is preferably detected in a step 330, and is again preferably transmitted to the apparatus 125 in a step 335. In a step 340, the apparatus 125 can update information about the construction project 130 that is affected by the investment instruction. In particular, information stored in the database 145 that relates to a funding status of the construction project 130 can be updated with information affected by the investment instruction. Prior to or after this, the investment instruction can be forwarded or activated in a step 345. In both cases, it is ensured that the resource released by the person 110 is provided for the realization of the construction project 130.

Optionally, the apparatus 125 can also check whether the total investment already made, that is, the total of all the funds already allocated for the construction project 130, is sufficient for the realization of the construction project 130. In this case, in a step 355, the construction project 130 can be cleared for implementation and the possibility of activating a further investment for the construction project 130 can be blocked. In one embodiment, the information about the construction project 130 is deleted from the database 145.

Although the invention has been illustrated and described in greater detail by the preferred embodiment, the invention is not limited to the examples disclosed and other variants can be derived therefrom by a person skilled in the art without departing from the scope of the invention.

1-8. (canceled)

9. An apparatus, comprising:
a database with information about construction projects for an infrastructure network, wherein a geographical area affected by a construction project is assigned to the construction project;
an interface for communicating with a mobile terminal belonging to a user;
a processing system configured to:
determine a position of the mobile terminal;
transmit information about the construction project to the mobile terminal, the geographical area assigned to the construction project containing the position; and
receive an investment instruction from the user of the mobile device to carry out the construction project.

10. The apparatus according to claim 9, wherein the investment instruction relates to a monetary amount and said processing system is equipped to carry out a transfer of the monetary amount from an account held by the user.

11. A method, which comprises the steps of:
determining a position of a mobile device;
detecting a construction project for an infrastructure network, wherein an affected geographical area of the infrastructure network that includes the position is assigned to the construction project;
transmitting information about the construction project to the mobile device; and
receiving an investment instruction from a user of the mobile device for implementation of the construction project.

12. The method according to claim 11, wherein the information includes at least one of a total investment required to carry out the construction project, a total investment from investment instructions already received, an investment total of investment instructions still required to implement the construction project, or a number of investment instructions received.

13. The method according to claim 11, wherein the infrastructure network includes a transport network.

14. The method according to claim 13, wherein the transport network includes a road network.

15. The method according to claim 14, wherein the information includes an indication of an intended impact of a completed construction project on traffic in an affected area of the infrastructure network.

16. A non-transitory computer-readable medium having computer executable instructions to be executable on a processing system for performing a method which comprises the steps of:
determining a position of a mobile device;
detecting a construction project for an infrastructure network, wherein an affected geographical area of the infrastructure network that includes the position is assigned to the construction project;
transmitting information about the construction project to the mobile device; and
receiving an investment instruction from a user of the mobile device for implementation of the construction project.
